(19) United States
(12) Patent Application Publication
(10) Pub. No.: US 2005/0187831 A1
(43) Pub. Date: Aug. 25, 2005

(54) Gem item report method and system

(76) Inventors: Mark Gershburg, Franklin Lakes, NJ (US); Nicholas Del Re, Brooklyn, NY (US); Sharrie Woodring, Woodbridge, NJ (US)

Correspondence Address: ANDERSON, KILL & OLICK, P.C., 1251 AVENUE OF THE AMERICAS, NEW YORK,, NY, 10020-1182, US

(21) Appl. No.: 10/786,680

(22) Filed: Feb. 25, 2004

(51) Int. Cl. G06F 17/60

(52) U.S. Cl. 705/27

(57) ABSTRACT

Embodiments of the present invention are directed to a method and system for a gem item report. In one embodiment of the present invention, a plurality of images of a gem item are stored as part of a report for the gem item. In one embodiment, a video of a gem item is stored as part of a report of the gem item. In another embodiment, the images display various characteristics of the gem item, including but not limited to the faceting arrangement, the inclusions, and any markings. In one embodiment, the images are of the gem item under magnification. In one embodiment, the images, taken together, provide a two dimensional or 360-degree three dimensional view of a gem item. In one embodiment, an interface is provided for viewing a stored image of a gem item from a desired perspective and at a desired magnification.

### FIELD OF THE INVENTION

The present invention relates to the field of gem items, and in particular to a method and system for gem item report.

### BACKGROUND

The term “gem item” can infer, but is not limited to, rough, cut, and faceted organic or inorganic gem materials. Gem items may also infer precious metals in the form of jewelry items, figures or other shapes with or without other gem items. Gem items (e.g., rough and cut gemstones, diamonds, rubies, sapphires, emeralds, precious metals, etc.) are valued according to their physical characteristics. Color, clarity, type and quality of cut, size, and fluorescence are some of the characteristics that may factor into determining a gem item's value. Additionally, the physical characteristics can be used to uniquely identify a gem item. Thus, when attempting to determine the quality of a gem item, recover a stolen gem item or detect a substituted gem item, it is desirable to have a report associated with the gem item that indicates physical characteristics about the gem item. However, prior art certificates are inefficient at documenting certain physical characteristics. This problem can be better understood with a review of gem item identification, authentication, evaluation, and valuation.

Gem Item Identification, Authentication, Evaluation, and Valuation

Identification, authentication, evaluation, and valuation of gem item are necessary to the gem item industry. Currently, gemological laboratories independent from the retailers and buyers of gem item evaluate or “grade” gem items such as diamonds using industry accepted standards. The independent laboratory then issues its findings in a report for that gem item, typically referred to as a “certificate.”

A typical example of a report for s gem item is a certificate for a gemstone. The gemstone certificate plays an important role in the sale or purchase of a gem. For example, a certificate can help ensure that a purchaser pays a fair price for the gemstone. Further, a certificate contains information that is useful in the identification and authentication of a gemstone. A diamond certificate, for example, typically reports a diamond's clarity, color, cut and carat characteristics (generally referred to as the 4Cs).

Clarity represents the relative absence of exclusions (external characteristics) and inclusions (internal characteristics) for gem items. With respect to diamonds, clarity is graded on a relative scale from flawless to included based on the size, nature, positions and quantity of clarity characteristics visible under 10× magnification. Since almost all diamonds have clarity characteristics, they are useful in identifying and authenticating a particular diamond. Further, clarity is useful in determining a diamond's value, since diamonds with fewer inclusions are rare and considered more valuable. On the other hand, a unique inclusion may actually increase the value of a diamond. Similar clarity considerations apply to many other types of gem items.

Color typically refers to the hue, tone, lightness and/or saturation of a gem item. Color generally assesses the absence of color in a diamond on a D to Z scale, from colorless to light yellow, brown or gray. Other colors such as pink are considered fancy colors and are described differently. Color grades are established by comparing the diamond to a set of standard master diamonds under controlled conditions. Color may affect the value of a diamond; for example, diamonds that are colorless are the rarest. Moreover, color may be useful in identifying and/or authenticating a particular diamond. Similar color considerations apply to many other gem items.

Gem items may be rough (i.e., uncut) or cut. A cut gem item is made to have one of a plurality of particular geometric shapes, such as brilliant, step, and mixed cuts. When referring to diamonds, cut refers to the shape and style of a polished diamond, such as a round brilliant, step, mixed, or emerald cut, as well as the proportions and finish of a diamond. Cut grading is the process of evaluating and describing the proportions and finish of a gem item, in the case of diamonds, principally with regard to their overall effect on brilliance, dispersion, and scintillation and the balance between them. While the cut of a diamond may increase or decrease its value, cut is one of the most obvious and useful ways to identify a diamond. Further, cut can be used to authenticate a particular stone.

A carat (ct.), or metric carat, is a standard unit of weight used for gem items. One carat equals 0.200 grams (or 200 milligrams). It is internationally recognized practice within the diamond industry to record weight in accordance with FTC regulations.

Other characteristics or information which may be included on a gem item report include measurements of the gem item, including minimum and maximum diameter; the total depth of the gem item from the table, or top, of the gem item to the culet, or point; average size of the table facet in relation to the average diameter for round shapes, or the width of the table in relation to the width of the gem item for fancy shapes; thickness of the girdle (middle of the gem item that separates the crown, or tip of the gem item from the pavilion, or bottom) relative to the size of the gem item and condition, e.g., polished or faceted, if applicable; size of the culet facet relative to the size of the gem item; finish grade representing the quality of the surface condition (polish) and size, shape and placement of the facets, including the symmetry, i.e., evenness of the outline; fluorescence, or the strength and color of a gem item when viewed under long wave ultraviolet light such as is present in daylight; additional comments on identifying characteristics or features of the gem item; markings such as any laser inscription on the gem item (e.g., a brand name, trade name, personal message or report number).

Currently existing diamond reports also include a printed diagram on a certificate which approximates the shape and/or cutting style of the stone and which plots the internal and external characteristics of the diamond. The diagram may include the type, positions and approximate size of a clarity characteristic. Similar information may be present in reports on other types of gem items. However, because these diagrams are frequently standard diagrams with any clarity characteristics hand-plotted, they are of limited use in the identification, authentication, evaluation and valuation of gem items.

Under most circumstances a standard diagram cannot accurately reflect the clarity of a particular gem item. Because the printed diagram shows a view of the gem item from only one angle, it is difficult to represent the location, shape of size of inclusions and/or exclusions. For example, a gem item may include a long, thin inclusion which would appear as a line through the gem item from certain angles and as a tiny pinpoint from other angles. Further, because such inclusions and extrusions are frequently plotted by hand on a standardized diagram, the location, shape and size of such markings are subject to human error.

Additionally, because the diagram is a standard diagram, it does not reflect the actual cut, if any, of a gem item. For example, round brilliant cut diamonds have various table sizes, which are not reflected in a standardized diagram of a brilliant cut diagram. Although the report may list the table size of the gem item, it may be difficult for the purchaser to visualize the cut of the actual gem item based on the standard diagram and the table size, or the purchaser may not fully understand that they table size of the actual gem item is bigger or smaller than the one shown in the standardized diagram.

Additionally, the standardized diagram does not reflect any markings (e.g., laser markings) on the gem item, such as a personal message or serial number useful in identifying and authenticating the gem item.

Further, it is often difficult for the purchaser to visualize a gem item based on the printed diagram. An individual who wished to purchase a gem item but could not view the gem item in person due to distance, for example, might find it difficult to visualize the individual characteristics of a gem item based on the standardized, printed diagram, which only showed the gem item from one angle.

Further, clarity enhancement may not be shown on or be evident from a prior art gem item report or diagram. Gem items may undergo clarity enhancement to approve the apparent clarity of the gem item, whereby fractures or cavities natural to the gem item are filled with some material (e.g., glass or resin). Whether or not a gem item has undergone clarity enhancement is usually invisible to the naked eye. However, clarity enhancement oftentimes affects the value of the gem item.

### SUMMARY OF THE INVENTION

Embodiments of the present invention are directed to a method and system for an gem item report. In one embodiment of the present invention, a plurality of images of a gem item is stored electronically as part of a report for the gem item. The electronic storage may be any of many readily known storage means, including but not limited to CD, DVD, disk drive, floppy disk, magnetic tape, or a smart card. In one embodiment, the images are in a digital format. In another embodiment, the images are in an analog format. In another embodiment, a plurality of images of a gem item is stored holographically. In yet another embodiment, a plurality of images of a gem item is stored via ionic implant. In still another embodiment, flash memory is used to store a plurality of images of a gem item. In various other embodiments, other methods of storing a plurality of images of a gem item are used.

In one embodiment, a video of a gem item is stored (e.g., electronically) as part of a report for the gem item. In another embodiment, the images display various characteristics of the gem item, including but not limited to the faceting arrangement, the inclusions, and any markings (e.g., laser inscriptions). In one embodiment, the images are of the gem item under magnification. The magnification may be of any power. In one embodiment, the magnification ranges between 10× and 400×, inclusive. In another embodiment, the magnification ranges between 1× and 1000×, inclusive. In another embodiment, the magnification ranges between 1× and 2000×, inclusive.

In one embodiment, the images, taken together, provide a 360-degree view of a gem item. In another embodiment, the images, taken together, provide a three dimensional view of the gem item. In one embodiment, a gem item is displayed three dimensionally. In still another embodiment, a photo-realistic rendering of the gem item is displayed. In one embodiment, the image is projected in mid-air using projection imagery techniques. In another embodiment, dual screen goggles are used to provide a three dimensional view of the images. In yet another embodiment, a gem item is displayed holographically.

In one embodiment, an interface is provided for viewing a stored image of a gem item from a desired perspective and at a desired magnification. If an image at the desired perspective and magnification is not available, the viewing attempt may fail or an alternate image that best fits the desired perspective and magnification may be displayed. In another embodiment, a display sequence for some or all of the images stored for a gem item is pre-determined.

In one embodiment, a silhouette image of a gem item by a metrological means (e.g., a morie pattern, holographic, photo-acoustic, or Sarin machine) that measures the proportions of the gem item is stored (e.g., electronically) as part of a report for the gem item. In one embodiment, the report for the gem item also includes grading data (e.g., the information contained in an EGL USA Certificate) stored (e.g., electronically, holographically, via ionic implant, etc.) as part of a report for the gem item. In one embodiment, some or all of the stored data of a report for the gem item contains hyperlinks. In one embodiment, one or more physical characteristics that are visible in an image are associated with a hyperlink. In a non-limiting example, selecting an inclusion in an image links to additional data on inclusions in general or that inclusion in particular (e.g., images showing the inclusion from different perspectives and/or magnifications). In another embodiment, a data item that is part of the grading data is associated with a hyperlink. In a non-limiting example, selecting the clarity rating links to one or more images displaying the inclusions of the gem item.

In yet another embodiment, educational and background material (e.g., information about gem item in general, information on this type of gem item, or information on this particular gem item, such as where it was unearthed, who cut the gem item and/or the geological history of the location at which the gem item was discovered) is stored (e.g., electronically, holographically, via ionic implant, or other chemical and/or genetic storage means) as part of a report for the gem item.

In one embodiment, the images are used to display some of the gem item's physical qualities to a potential buyer. In another embodiment, the images are used to identify a gem item. Images may be transmitted (e.g., electronically) to an interested party (e.g., a potential buyer, a relative or friend, or a victim of gem item theft). For example, a newly engaged bride-to-be may transmit the images of the report to her mother. In yet another embodiment, the images are used to train gem item cutters. In still other embodiments, the images are used to train others in education and/or research.

In one embodiment, the report of the present invention includes the shape and cutting style of the gem item; measurements of the gem item; weight and proportions of the gem item, including minimum and maximum diameter; the total depth of the gem item from the table, or top, of the gem item to the culet, or point; average size of the table facet in relation to the average diameter for round shapes, or the width of the table in relation to the width of the gem item for fancy shapes; thickness of the girdle, relative to the size of the gem item and condition, e.g., polished or faceted, if applicable; size of the culet facet relative to the size of the gem item; finish grade representing the quality of the surface condition (polish) and size, shape and placement of the facets, including the symmetry, i.e., evenness of the outline; fluorescence, or the strength, color, and spectrum of a gem item when viewed under long wave ultraviolet light such as is present in daylight (or any other wavelength from the electromagnetic spectrum such as visible, UV, infrared, X-ray, radio, gamma, etc.); additional comments on identifying characteristics or features of the gem item; and/or any markings (e.g., a laser inscription, focused ion beam, dip pen nanolithography, photolithography, microlithography, etc.) on the gem item, such as a brand name, trade name, personal message or report number. In an alternative embodiment, such information is presented in printed format in combination with the report stored via another means (e.g., electronically, holographically, via ionic implant, genetically, etc.).

In one embodiment, a report is packaged with a printed version. For example, the report data is stored on a CD and a printed version of the report is the label of the CD. In another embodiment, the report data is stored on a smart card and a printed version of the report is shown on the smart card.

### BRIEF DESCRIPTION OF THE DRAWINGS

These and other features, aspects and advantages of the present invention will become better understood with regard to the following description, appended claims and accompanying drawings where:

FIG. 1 is a flow diagram of a non-limiting process of creating a report for a gem item in accordance with one embodiment of the present invention.

FIG. 2 is a flow diagram of a non-limiting process of creating a gem item report in accordance with one embodiment of the present invention.

FIG. 3 is a flow diagram of a non-limiting process of creating a gem item report with a 360-degree view of a gem item in accordance with one embodiment of the present invention.

FIG. 4 is a flow diagram of a non-limiting process of displaying a three dimensional image of a gem item in accordance with one embodiment of the present invention.

FIG. 5 is a flow diagram of a non-limiting process of viewing a gem item image in accordance with one embodiment of the present invention.

FIG. 6 is a flow diagram of a non-limiting process for viewing information electronically stored as part of a report for a gem item in accordance with one embodiment of the present invention.

FIG. 7 is a flow diagram of a non-limiting process for determining whether a gem item is the gem item associated with a report in accordance with one embodiment of the present invention.

FIG. 8 is a flow diagram of a non-limiting process for transmitting gem item report data in accordance with one embodiment of the present invention.

FIG. 9 is a block diagram of a non-limiting general purpose computer.

### DETAILED DESCRIPTION OF THE INVENTION

The invention is a method and system for a gem item report. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Images Stored as Part of Gem Item Report

Embodiments of the present invention are directed to a method and apparatus for a gem item report. A report may include a prior art certificate, some portion of the data included in prior art certificates, and/or additional data not previously included in prior art certificates. In one embodiment of the present invention, a plurality of images of a gem item is stored as part of a report for the gem item. Various storage methods (e.g., electronic, holographic, ionic implant, chemical, molecular, genetic, etc.) are used in various embodiments. The images may be collected by any of many readily known image capturing devices, including but not limited to a video camera, a digital video recorder, a camera, a digital camera, or an electron microscope. The electronic storage may be any of many readily known storage means, including but not limited to CD, DVD, disk drive, floppy disk, magnetic tape, flash memory, or a smart card. In one embodiment, the images are in a digital format. In another embodiment, the images are in an analogue format.

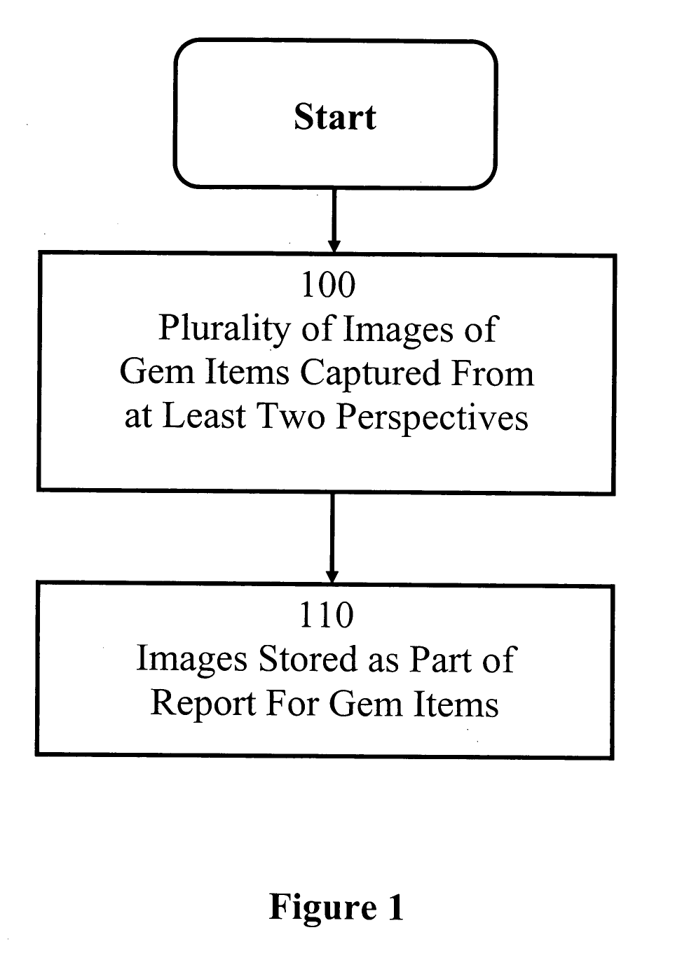

FIG. 1 illustrates a non-limiting process of creating a report for a gem item in accordance with one embodiment of the present invention. At block 100, a plurality of images of a gem item is captured from at least two perspectives. At block 110, the images are stored (e.g., electronically) as part of a report for the gem item.

In one embodiment, a video of a gem item is stored as part of a report for the gem item. In another embodiment, the images display various characteristics of the gem item, including but not limited to the faceting arrangement, the inclusions, and any markings (e.g., laser inscriptions, focused ion beam, dip pen nanolithography, photolithography, microlithography, etc.) on the girdle or other part of the gem item. In one embodiment, the images are of the gem item under magnification. The magnification may be of any power. In one embodiment, the magnification ranges between 10× and 400×, inclusive. In another embodiment, the magnification ranges between 1× and 1000×, inclusive. In still another embodiment, the magnification ranges between 1× and 2000×, inclusive.

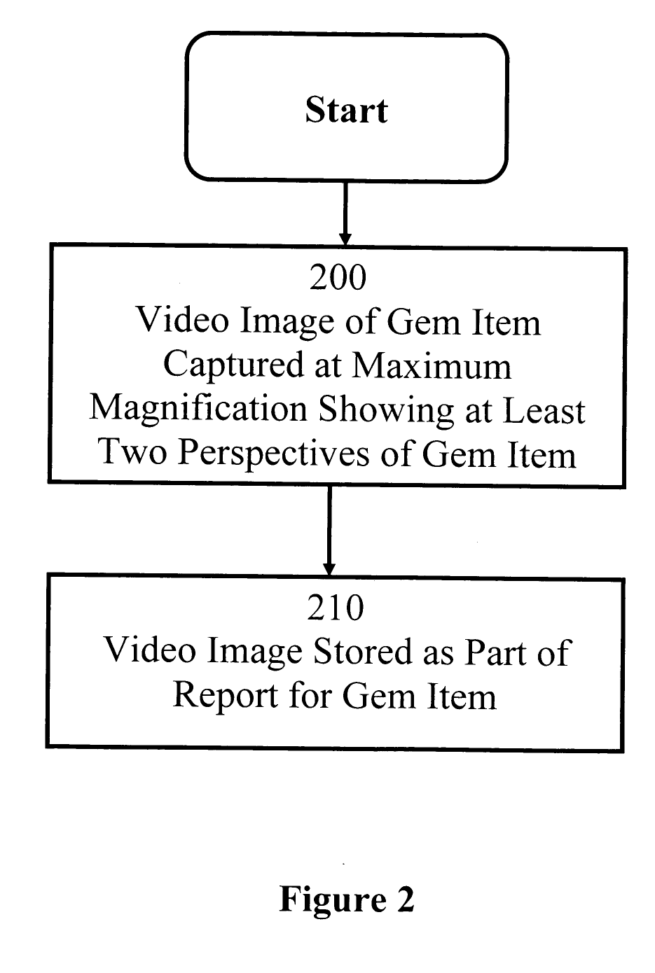

FIG. 2 illustrates a non-limiting process of creating a gem item report in accordance with one embodiment of the present invention. At block 200, a video image of a gem item is captured at a maximum magnification showing at least two perspectives of the gem item. At block 210, the video image is stored (e.g., electronically) as part of a report for the gem item. In another embodiment, instead of only capturing images at maximum magnification, images are captured at a range of magnifications.

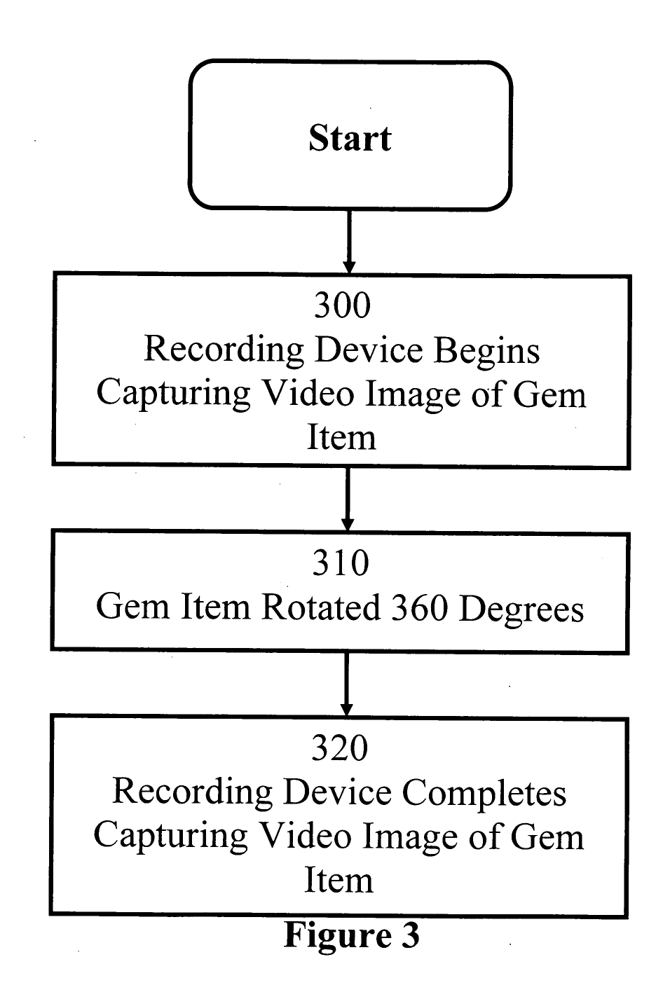

In one embodiment, the images, taken together, provide a 360-degree view of a gem item. FIG. 3 illustrates a non-limiting process of creating a gem item report with a 360-degree view of a gem item in accordance with one embodiment of the present invention. At block 300, a recording device begins capturing a video image of a gem item. At block 310, the gem item is rotated 360 degrees. At block 320, the recording device completes capturing the video image of the gem item. In another embodiment, the gem item is further rotated about another axis such that images from perspectives that uniformly cover three dimensional space are captured. In still another embodiment, the camera is rotated instead of or in addition to the gem item. In yet another embodiment, enough data about the gem item is captured to enable production of a photorealistic image of the gem item.

Three Dimensional Image of Gem Item

In another embodiment, the images, taken together, provide a three dimensional view of the gem item. In one embodiment, a gem item is displayed three dimensionally. In one embodiment, the image is projected in mid-air using projection imagery techniques. In another embodiment, dual screen goggles are used to provide a three dimensional view of the images. In still another embodiment, a photorealistic image of the gem item is displayed. The photorealistic image may be generated by software or hardware from metrological data about the gem item. In other embodiments, the images provide a two dimensional view of the gem. In various embodiments, a two dimensional view of the gem is displayed using any of various methods for displaying two or three dimensional images.

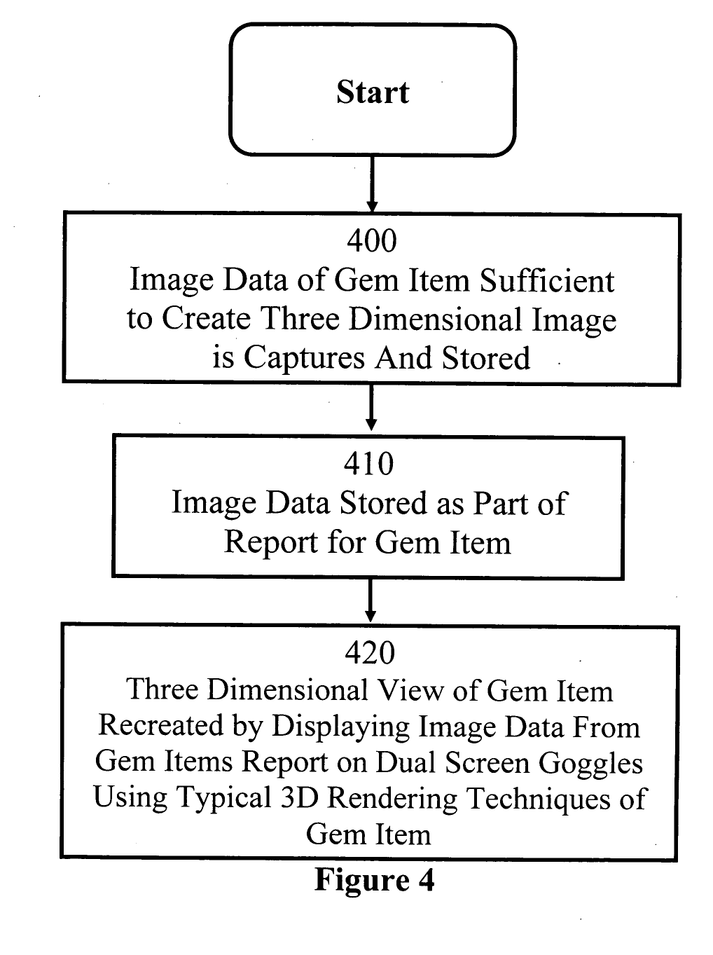

FIG. 4 illustrates a non-limiting process of displaying a three dimensional image of a gem item in accordance with one embodiment of the present invention. At block 400, image data of a gem item sufficient to create a three dimensional image is captured and stored (e.g., electronically). The image data may be captured using a 3D camera (or other 3D image capturing device), or a series of images with different perspectives may be captured by non-3D camera (or other image capturing device) and formed into a three dimensional image using computer software or hardware. At block 410, the image data is stored as part of a report for the gem item. At block 420, a three dimensional view of the gem item is recreated by displaying image data from the gem item's report on dual screen goggles using typical 3D rendering techniques.

Perspective Views

In one embodiment, an interface is provided for viewing a stored image of a gem item from a desired perspective and at a desired magnification. If an image at the desired perspective and magnification is not available, the viewing attempt may fail or an alternate image that best fits the desired perspective and magnification may be displayed. In another embodiment, a display sequence for some or all of the images stored for a gem item is pre-determined.

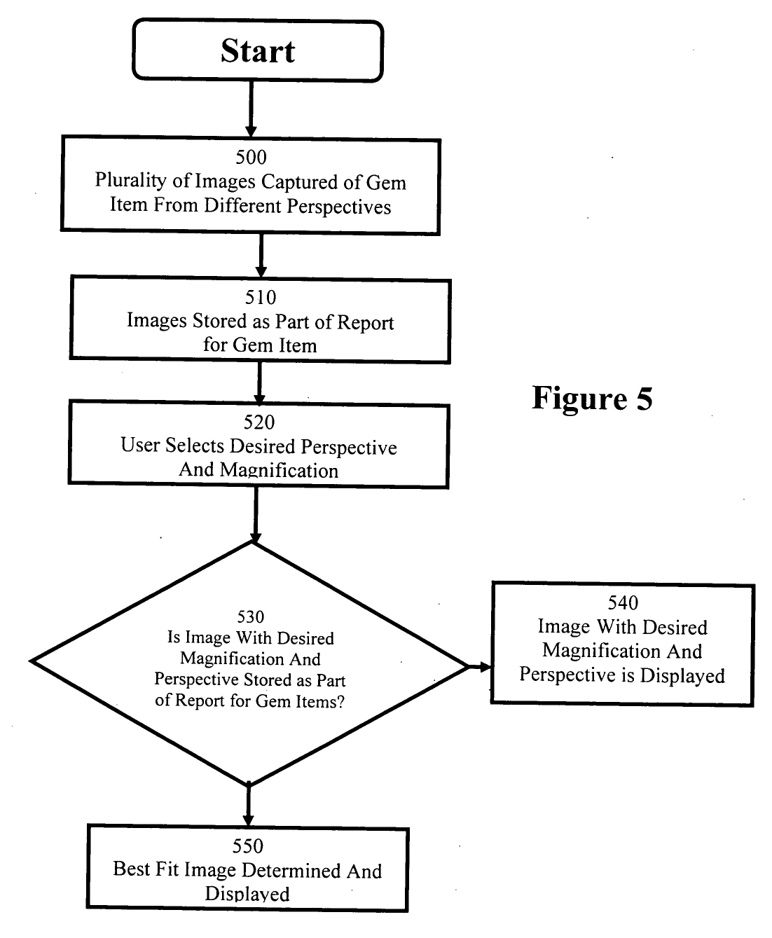

FIG. 5 illustrates a non-limiting process of viewing a gem item image in accordance with one embodiment of the present invention. At block 500, a plurality of images is captured of a gem item from different perspectives. At block 510, the images are stored as part of a report for a gem item. At block 520, a user selects a desired perspective and magnification. A user may select a perspective by entering a viewing coordinate, by manipulating a mouse or other input device to indicate a desired perspective change from a displayed image of the gem item, or by some other method. Similarly, a user may select a magnification by entering a magnification, by manipulating an input device to indicate a desired magnification change from a current magnification.

At block 530, it is determined whether an image with the desired magnification and perspective are stored as part of the report for the gem item. If an image with the desired magnification and perspective are stored as part of the report for the gem item, at block 540, the image with the desired magnification and perspective is displayed. If an image with the desired magnification and perspective is not stored as part of the report for the gem item, at block 550, a best fit image is determined and displayed.

Additional Report Information

In one embodiment, measurements of a gem item (e.g., a silhouette image of a gem item by a Sarin machine) made by a metrological means that measures the proportions of the gem item is stored as part of a report for the gem item. In one embodiment, the report for the gem item also includes grading data (e.g., cut, color, clarity, carat weight, etc.) stored as part of a certificate for the gem item. Such grading data including, but not limited to, the shape and cutting style of the gem item; measurements of the gem item; weight and proportions of the gem item, including minimum and maximum diameter; the total depth of the gem item from the table, or top, of the gem item to the culet, or point; average size of the table facet in relation to the average diameter for round shapes, or the width of the table in relation to the width of the gem item for fancy shapes; thickness of the girdle, relative to the size of the gem item and condition, e.g., polished or faceted, if applicable; size of the culet facet relative to the size of the gem item; finish grade representing the quality of the surface condition (polish) and size, shape and placement of the facets, including the symmetry, i.e., evenness of the outline; fluorescence, or the strength and color of a gem item when viewed under long wave ultraviolet light such as is present in daylight or other wavelengths in the electromagnetic spectrum (e.g., visible, infrared, radio, gamma, X-ray, etc.).

In another embodiment, the report includes a spectral graph representation. In one embodiment, the report includes an absorption spectral graph representation. In another embodiment, the report includes a transmittance spectral graph representation. The report may also include additional comments on identifying characteristics or features of the gem item, and/or any markings (e.g., laser inscription, focused ion beam, dip pen nanolithography, photolithography, microlithography, etc.) on the stone, such as a brand name, trade name, personal message or report number. In various embodiments, the report may include data about a gem item's morphology, crystalline structure, color, weight, chemical composition, physical and/or chemical characteristics, and treatment information (e.g., any thermal, chemical, irradiation, coating, clarity, diffusion, or other treatment information). In an alternative embodiment, the report for a gem item comprises a plurality of images of the gem item, which are stored (e.g., electronically), and grading data in printed format.

In one embodiment, some or all of the stored data of a report for the gem item contains hyperlinks. In one embodiment, one or more physical characteristics that are visible in an image are associated with a hyperlink. In a non-limiting example, selecting an inclusion in an image links to additional data on inclusions in general or that inclusion in particular (e.g., images showing the inclusion from different perspectives and/or magnifications). In another embodiment, a data item that is part of the grading data is associated with a hyperlink. In a non-limiting example, selecting the clarity rating links to one or more images displaying the inclusions of the gem item.

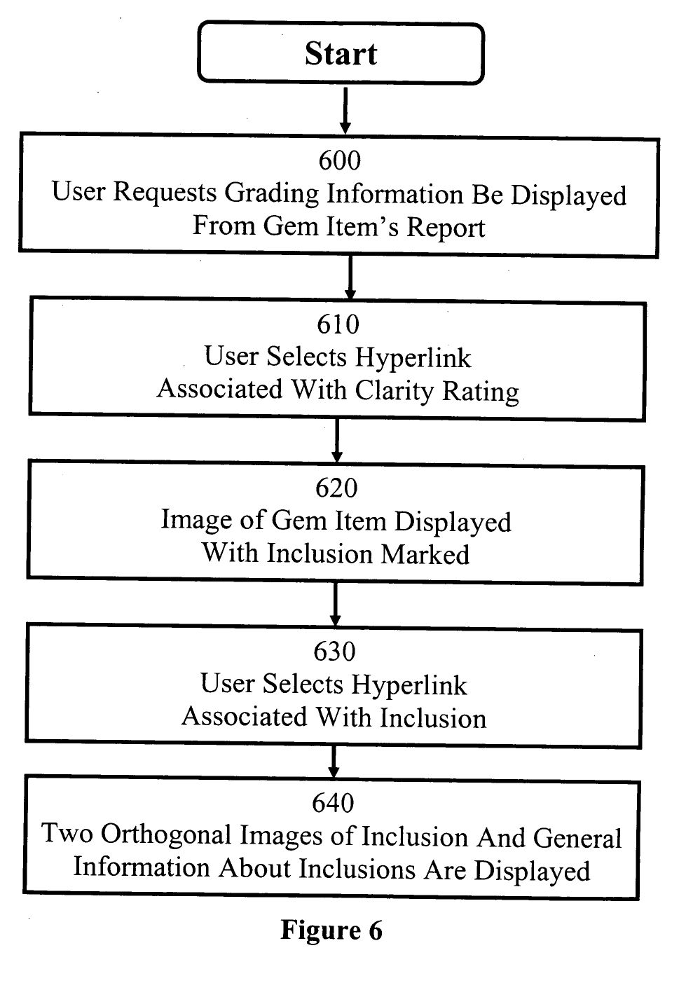

FIG. 6 illustrates a non-limiting process for viewing information stored as part of a report for a gem item in accordance with one embodiment of the present invention. At block 600, a user requests grading information be displayed from a gem item's report. At block 610, the user selects a hyperlink associated with the clarity rating. At block 620, an image of the gem item is displayed with an inclusion marked. At block 630, the user selects a hyperlink associated with the inclusion. At block 640, two orthogonal images of the inclusion and general information about inclusions are displayed. In another embodiment, the two images displayed in block 640 are not necessarily orthogonal.

In yet another embodiment, educational and background material (e.g., information about gem item in general, information about this type of gem item, or information on this particular gem item, such as where it was unearthed, who cut the gem item and/or the geological history of the location at which the gem item was discovered) is stored as part of a report for the gem item.

Displaying Reports

In one embodiment, one or more images of a report are used to display some of the gem item's physical qualities to a potential buyer. In one embodiment, important features of the gem item are illustrated in the images. Thus, a buyer may obtain an understanding of the quality of the gem item not available before either due to remoteness from the gem item at the time of purchase or to the buyer's inexperience at assessing a gem item's physical characteristics.

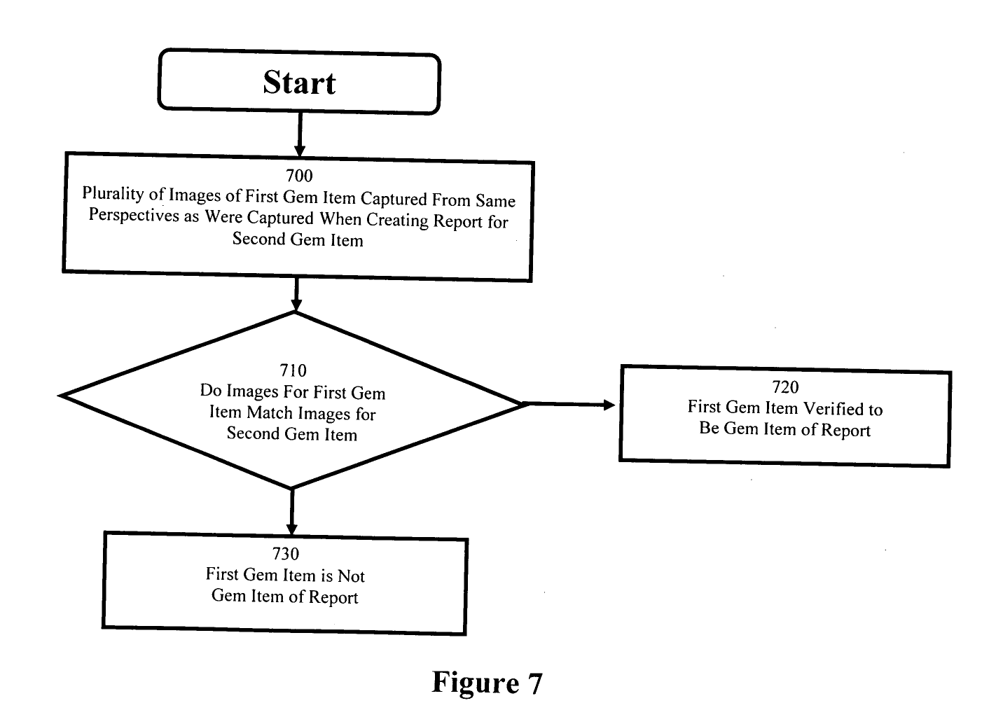

In another embodiment, the images are used to identify a gem item. Thus, images of a gem item from the report can be compared with newly obtained images to determine whether a gem item is the gem item of the report. FIG. 7 illustrates a non-limiting process for determining whether a gem item is the gem item associated with a report in accordance with one embodiment of the present invention. At block 700, a plurality of images of a first gem item are captured from the same perspectives as were captured when certifying (or creating a report for) a second gem item. At block 710, it is determined whether the images for the first gem item match the images for the second gem item. A match may be required to be exact, or a range of tolerances may be allowed to accommodate slight differences in perspective or changes to the gem item. If the images for the first gem item match the images for the second gem item, at block 720, the first gem item is verified to be the gem item of the report. If images for the first gem item do not match images for the second gem item, at block 730, the first gem item is not the gem item of the report.

In one embodiment, the images for the second gem item which are used to verify the identity of the first gem item are stored in a database and are accessible via a hyperlink associated with the images of the first gem item. In another embodiment, treatment information about a gem item is used to identify an unknown gem item or to authenticate a gem item.

Transmitting Report Data

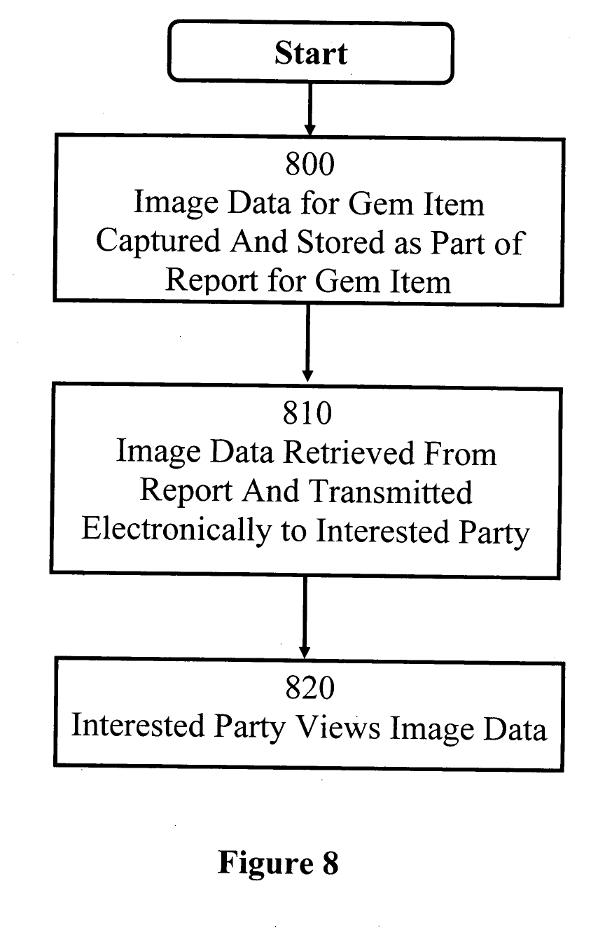

Images may be transmitted (e.g., electronically) to an interested party (e.g., a potential buyer, a relative or friend, or a victim of gem item theft). For example, a newly engaged bride-to-be may transmit the images of the report to her mother. In yet another embodiment, the images are used to train gem item cutters. FIG. 8 illustrates a non-limiting process for transmitting gem item report data in accordance with one embodiment of the present invention. At block 800, image data for a gem item is captured and stored as part of a report for the gem item. At block 810, the image data is retrieved from the report and transmitted electronically to an interested party. Any electronic transmission method (e.g., e-mail attachment, FTP, web page, etc.) may be used. Further, the data may be in any electronic format (e.g., JPG, GIF, MPEG, AVI, etc.). At block 820, the interested party views the image data.

Printed Report Data

In one embodiment, report is packaged with a printed version. For example, the report data is stored on a CD and a printed version of the report is the label of the CD. In another embodiment, the printed version of the report merely accompanies the gem item report.

Report Authenticity

In one embodiment, the authenticity for a report is ensured by an encryption scheme. In another embodiment, report information provided in a hard copy (e.g., printed) format is encrypted and may only be verified as the true report for the gem item by a special reading device. In one embodiment, a hardware device (e.g., a special reader device) is required to decrypt and authenticate the report. In an example embodiment, an image of the report is encrypted (e.g., holographically or otherwise). The image may be decrypted and viewed by insertion into a reading device. Thus the authenticity of the report and the identifying data of gem item may be verified.

In another embodiment, a decryption key is placed upon the gem item (e.g., by physical or chemical marking). The gem item is inserted into a reading device, and if the decryption key matches the key required to decrypt the report for the gem item, the report is decrypted and may be authenticated.

Embodiment of Computer Execution Environment (Hardware)

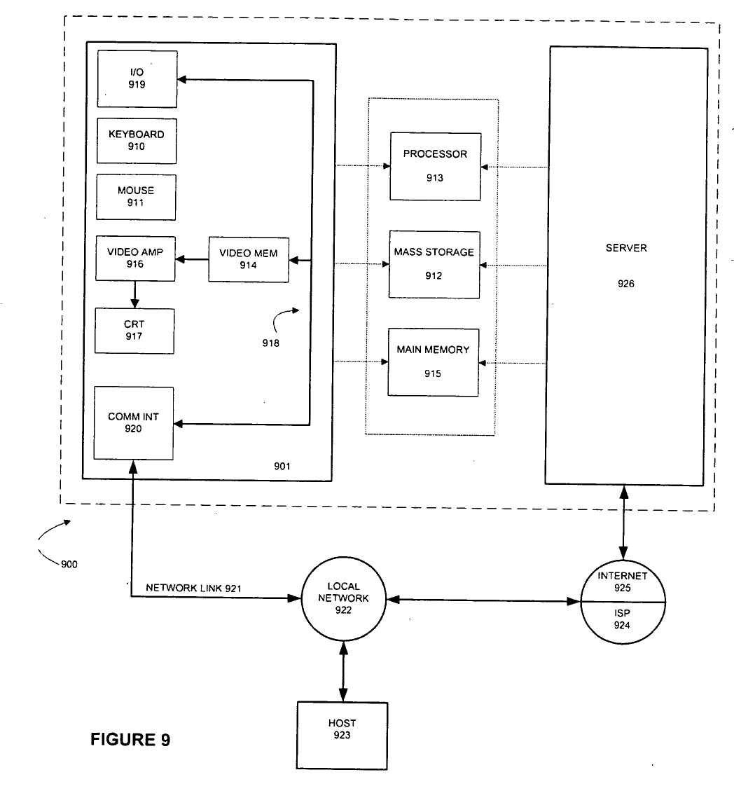

An embodiment of the invention can be implemented as computer software in the form of computer readable program code executed in a general purpose computing environment such as environment 900 illustrated in FIG. 9. A keyboard 910 and mouse 911 are coupled to a system bus 918. The keyboard and mouse are for introducing user input to the computer system and communicating that user input to central processing unit (CPU) 913. Other suitable input devices may be used in addition to, or in place of, the mouse 911 and keyboard 910. I/O (input/output) unit 919 coupled to bi-directional system bus 918 represents such I/O elements as a printer, A/V (audio/video) I/O, etc.

Computer 901 may include a communication interface 920 coupled to bus 918. Communication interface 920 provides a two-way data communication coupling via a network link 921 to a local network 922. For example, if communication interface 920 is an integrated services digital network (ISDN) card or a modem, communication interface 920 provides a data communication connection to the corresponding type of telephone line, which comprises part of network link 921. If communication interface 920 is a local area network (LAN) card, communication interface 920 provides a data communication connection via network link 921 to a compatible LAN. Wireless links are also possible. In any such implementation, communication interface 920 sends and receives electrical, electromagnetic or optical signals which carry digital data streams representing various types of information.

Network link 921 typically provides data communication through one or more networks to other data devices. For example, network link 921 may provide a connection through local network 922 to local server computer 923 or to data equipment operated by ISP 924. ISP 924 in turn provides data communication services through the world wide packet data communication network now commonly referred to as the “Internet” 925. Local network 922 and Internet 925 both use electrical, electromagnetic or optical signals which carry digital data streams. The signals through the various networks and the signals on network link 921 and through communication interface 920, which carry the digital data to and from computer 900, are exemplary forms of carrier waves transporting the information.

Processor 913 may reside wholly on client computer 901 or wholly on server 926 or processor 913 may have its computational power distributed between computer 901 and server 926. Server 926 symbolically is represented in FIG. 9 as one unit, but server 926 can also be distributed between multiple “tiers”. In one embodiment, server 926 comprises a middle and back tier where application logic executes in the middle tier and persistent data is obtained in the back tier. In the case where processor 913 resides wholly on server 926, the results of the computations performed by processor 913 are transmitted to computer 901 via Internet 925, Internet Service Provider (ISP) 924, local network 922 and communication interface 920. In this way, computer 901 is able to display the results of the computation to a user in the form of output.

Computer 901 includes a video memory 914, main memory 915 and mass storage 912, all coupled to bi-directional system bus 918 along with keyboard 910, mouse 911 and processor 913. As with processor 913, in various computing environments, main memory 915 and mass storage 912, can reside wholly on server 926 or computer 901, or they may be distributed between the two.

The mass storage 912 may include both fixed and removable media, such as magnetic, optical or magnetic optical storage systems or any other available mass storage technology. Bus 918 may contain, for example, thirty-two address lines for addressing video memory 914 or main memory 915. The system bus 918 also includes, for example, a 32-bit data bus for transferring data between and among the components, such as processor 913, main memory 915, video memory 914 and mass storage 912. Alternatively, multiplex data/address lines may be used instead of separate data and address lines.

In one embodiment of the invention, the microprocessor is manufactured by Intel, such as the 80×86 or Pentium-typed processor. However, any other suitable microprocessor or microcomputer may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the cathode ray tube (CRT) raster monitor 917. Video amplifier 916 is well known in the art and may be implemented by any suitable apparatus. This circuitry converts pixel data stored in video memory 914 to a raster signal suitable for use by monitor 917. Monitor 917 is a type of monitor suitable for displaying graphic images.

Computer 901 can send messages and receive data, including program code, through the network(s), network link 921, and communication interface 920. In the Internet example, remote server computer 926 might transmit a requested code for an application program through Internet 925, ISP 924, local network 922 and communication interface 920. The received code may be executed by processor 913 as it is received, and/or stored in mass storage 912, or other non-volatile storage for later execution. In this manner, computer 900 may obtain application code in the form of a carrier wave. Alternatively, remote server computer 926 may execute applications using processor 913, and utilize mass storage 912, and/or video memory 915. The results of the execution at server 926 are then transmitted through Internet 925, ISP 924, local network 922 and communication interface 920. In this example, computer 901 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for electronic digital certificate is described in conjunction with one or more specific embodiments. The invention is defined by the following claims and their full scope and equivalents.

1. A method for gem item report generation comprising the steps of:
capturing a first image of a gem item;
capturing a second image of said gem item;
storing said first image as part of a report for said gem item; and
storing said second image as part of said report for said gem item.

2. The method of claim 1 wherein said first image is captured from a first perspective and wherein said second image is captured from a second perspective.

3. The method of claim 1 wherein said first image is captured at a first magnification level and wherein said second image is captured at a second magnification level.

4. The method of claim 1 wherein said first image and said second image are part of a plurality of images that form a 360-degree view of said gem item.

5. The method of claim 1 further comprising the step of:
displaying a three dimensional image of said gem item wherein said three dimensional image is formed from data stored in said report.

6. The method of claim 1 further comprising the steps of:
selecting a perspective by a user; and
displaying said first image.

7. The method of claim 6 wherein said first image is from said perspective.

8. The method of claim 6 wherein said first image is a best fit for said perspective in a plurality of images of said gem item that are stored as part of said report.

9. The method of claim 1 further comprising the steps of:
selecting a magnification level by a user; and
displaying said first image.

10. The method of claim 9 wherein said first image is at said magnification level.

11. The method of claim 9 wherein said first image is a best fit for said magnification level in a plurality of images of said gem item that are stored as part of said report.

12. The method of claim 1 further comprising the step of:
displaying a plurality of images stored as part of said report in a pre-determined order.

13. The method of claim 1 further comprising the steps of:
associating a hyperlink to a second data item with a first data item; and
storing said first data item and said hyperlink as part of said report.

14. The method of claim 1 further comprising the steps of:
displaying said first image to an interested party.

15. The method of claim 14 wherein said interested party is a potential buyer.

16. The method of claim 14 wherein said interested party is a student.

17. The method of claim 16 wherein said student is learning to cut a type of gem item.

18. The method of claim 16 wherein said student is learning to appraise a type of gem item.

19. The method of claim 1 further comprising the steps of:
capturing a third image of a second gem item;
comparing said third image to said first image; and
determining whether said second gem item is said gem item.

20. The method of claim 1 further comprising the steps of:
transmitting said first image from a first location to a second location.

21. The method of claim 1 further comprising the steps of:
packaging a printed version of said report together with said report.

22. The method of claim 1 further comprising the step of:
displaying a photorealistic image of said gem item wherein said photorealistic image is formed from data stored in said report.

23. The method of claim 1 wherein said step of storing said first image comprises the step of:
storing said first image as part of a report for said gem item electronically.

24. The method of claim 1 wherein said step of storing said first image comprises the step of:
storing said first image as part of a report for said gem item holographically.

25. The method of claim 1 wherein said step of storing said first image comprises the step of:
storing said first image as part of a report for said gem item via ionic implant.

26. The method of claim 1 wherein said step of storing said first image comprises the step of:
storing said first image as part of a report for said gem item genetically.

27. The method of claim 1 wherein said step of storing said first image comprises the step of:
storing said first image as part of a report for said gem item chemically.

28. The method of claim 1 further comprising the step of:
encrypting a data item of said report.

29. A method of determining authenticity of a first gem item comprising the steps of:
generating a report for a second gem item wherein said report comprises:
a first image of said second gem item; and
a second image of said second gem item; and
comparing a feature of said first gem item to a data item in said report.

30. A method of determining authenticity of a report comprising the steps of:
generating a report for a gem item wherein said report comprises:
a first image of said gem item; and
a second image of said gem item; and
encrypting a data item of said report;
attempting to decrypt said data item; and
authenticating said report if said data item is decrypted successfully.

31. The method of claim 30 wherein said step of attempting comprises the step of:
using a reading device.

32. A method of informing comprising the steps of:
capturing a first image of a gem item;
capturing a second image of said gem item;
storing said first image as part of a report for said gem item;
storing said second image as part of said report for said gem item; and
displaying a data item of said report to a viewer.

33. The method of claim 32 wherein said viewer is a student.

34. The method of claim 33 wherein said viewer is a researcher.

35. A gem item report system comprising:
a first image of a gem item;
a second image of said gem item;
a storage unit configured to store said first image and said second image as part of a report for said gem item.

36. The gem item report system of claim 35 wherein said first image is captured from a first perspective and wherein said second image is captured from a second perspective.

37. The gem item report system of claim 35 wherein said first image is captured at a first magnification level and wherein said second image is captured at a second magnification level.

38. The gem item report system of claim 35 wherein said first image and said second image are part of a plurality of images that form a 360-degree view of said gem item.

39. The gem item report system of claim 35 further comprising:
a display unit configured to display a three dimensional image of said gem item wherein said three dimensional image is formed from data stored in said report.

40. The gem item report system of claim 35 further comprising:
a selection unit configured to select a perspective by a user; and
a display unit configured to display said first image.

41. The gem item report system of claim 40 wherein said first image is from said perspective.

42. The gem item report system of claim 40 wherein said first image is a best fit for said perspective in a plurality of images of said gem item that are stored as part of said report.

43. The gem item report system of claim 35 further comprising:
a selection unit configured to select a magnification level by a user; and
a display unit configured to display said first image.

44. The gem item report system of claim 43 wherein said first image is at said magnification level.

45. The gem item report system of claim 43 wherein said first image is a best fit for said magnification level in a plurality of images of said gem item that are stored as part of said report.

46. The gem item report system of claim 35 further comprising:
a display unit configured to display a plurality of images stored as part of said report in a pre-determined order.

47. The gem item report system of claim 35 further comprising:
a hyperlink unit configured to associate a hyperlink to a second data item with a first data item, wherein said storage unit is further configured to store said first data item and said hyperlink as part of said report.

48. The gem item report system of claim 35 further comprising:
a display unit configured to display said first image to an interested party.

49. The gem item report system of claim 48 wherein said interested party is a potential buyer.

50. The gem item report system of claim 48 wherein said interested party is a student.

51. The gem item report system of claim 50 wherein said student is learning to cut a type of gem item.

52. The gem item report system of claim 50 wherein said student is learning to appraise a type of gem item.

53. The gem item report system of claim 35 further comprising:
a third image of a second gem item;
a comparing unit configured to compare said third image to said first image; and
a determiner configured to determine whether said second gem item is said gem item.

54. The gem item report system of claim 35 further comprising:
a transmitter configured to transmit said first image from a first location to a second location.

55. The gem item report system of claim 35 further comprising:
a printed version of said report wherein said printed version is packaged together with said report.

56. The gem item report system of claim 35 further comprising:
a display unit configured to display a photorealistic image of said gem item wherein said photorealistic image is formed from data stored in said report.

57. The gem item report system of claim 35 wherein said storage unit stores electronically.

58. The gem item report system of claim 35 wherein said storage unit stores holographically.

59. The gem item report system of claim 35 wherein said storage unit stores via ionic implant.

60. The gem item report system of claim 35 wherein said storage unit stores genetically.

61. The gem item report system of claim 35 wherein said storage unit stores chemically.

62. The gem item report system of claim 35 further comprising:
an encryption unit configured to encrypt a data item of said report.

63. A gem item authenticating system comprising:
a report for a first gem item comprising:
a first image of said first gem item; and
a second image of said first gem item; and
a comparing unit configured to compare a feature of a second gem item to a data item in said report.

64. A report authenticating system comprising:
a report for a gem item wherein said report comprises:
a first image of said gem item; and
a second image of said gem item; and
an encryption unit configured to encrypt a data item of said report;
a decryption unit configured to attempt to decrypt said data item; and
an authenticating unit configured to authenticate said report if said data item is decrypted successfully.

65. The report authenticating system of claim 64 wherein said decryption unit comprises: a reading device.

66. An information system comprising:
a first image of a gem item;
a second image of said gem item;
a storage unit configured to store said first image and said second image as part of a report for said gem item; and
a display unit configured to display a data item of said report to a viewer.

67. The method of claim 66 wherein said viewer is a student.

68. The method of claim 66 wherein said viewer is a researcher.

69. A computer program product comprising:
a computer usable medium having computer readable program code embodied therein configured to operate a gem item report system, said computer program product comprising:
computer readable code configured to cause a computer to capture a first image of a gem item;
computer readable code configured to cause a computer to capture a second image of said gem item;
computer readable code configured to cause a computer to store said first image as part of a report for a gem item; and
computer readable code configured to cause a computer to store said second image as part of said report for said gem item.

70. The computer program product of claim 69 wherein said computer readable code configured to cause a computer to capture said first image is further configured to capture said first image from a first perspective, and wherein said computer readable code configured to cause a computer to capture said second image is further configured to capture said second image from a second perspective.

71. The computer program product of claim 69 wherein said computer readable code configured to cause a computer to capture said first image is further configured to capture said first image at a first magnification level, and wherein said computer readable code configured to cause a computer to capture said second image is further configured to capture said second image at a second magnification level.

72. The computer program product of claim 69 wherein said first image and said second image are part of a plurality of images that form a 360-degree view of said gem item.

73. The computer program product of claim 69 further comprising:
computer readable code configured to cause a computer to display a three dimensional image of said gem item wherein said three dimensional image is formed from data stored in said report.

74. The computer program product of claim 69 further comprising:
computer readable code configured to cause a computer to select a perspective by a user; and
computer readable code configured to cause a computer to display said first image.

75. The computer program product of claim 74 wherein said first image is from said perspective.

76. The computer program product of claim 74 wherein said first image is a best fit for said perspective in a plurality of images of said gem item that are stored as part of said report.

77. The computer program product of claim 69 further comprising:
computer readable code configured to cause a computer to select a magnification level by a user; and
computer readable code configured to cause a computer to display said first image.

78. The computer program product of claim 77 wherein said first image is at said magnification level.

79. The computer program product of claim 77 wherein said first image is a best fit for said magnification level in a plurality of images of said gem item that are stored as part of said report.

80. The computer program product of claim 69 further comprising:
computer readable code configured to cause a computer to display a plurality of images stored as part of said report in a predetermined order.

81. The computer program product of claim 69 further comprising:
computer readable code configured to cause a computer to associate a hyperlink to a second data item with a first data item; and
computer readable code configured to cause a computer to store said first data item and said hyperlink as part of said report.

82. The computer program product of claim 69 further comprising:
computer readable code configured to cause a computer to display said first image to an interested party.

83. The computer program product of claim 82 wherein said interested party is a potential buyer.

84. The computer program product of claim 82 wherein said interested party is a student.

85. The computer program product of claim 84 wherein said student is learning to cut a type of gem item.

86. The computer program product of claim 84 wherein said student is learning to appraise a type of gem item.

87. The computer program product of claim 69 further comprising:
computer readable code configured to cause a computer to capture a third image of a second gem item;
computer readable code configured to cause a computer to compare said third image to said first image; and
computer readable code configured to cause a computer to determine whether said second gem item is said gem item.

88. The computer program product of claim 69 further comprising:
computer readable code configured to cause a computer to transmit said first image from a first location to a second location.

89. The computer program product of claim 69 further comprising:
computer readable code configured to cause a computer to create a printed version of said report wherein said printed version is packaged together with said report.

90. The computer program product of claim 69 further comprising:
computer readable code configured to cause a computer to display a photorealistic image of said gem item wherein said photorealistic image is formed from data stored in said report.

91. The computer program product of claim 69 wherein said computer readable code configured to cause a computer to store said first image is further configured to cause a computer to store said first image electronically.

92. The computer program product of claim 69 wherein said computer readable code configured to cause a computer to store said first image is further configured to cause a computer to store said first image holographically.

93. The computer program product of claim 69 wherein said computer readable code configured to cause a computer to store said first image is further configured to cause a computer to store said first image via ionic implant.

94. The computer program product of claim 69 wherein said computer readable code configured to cause a computer to store said first image is further configured to cause a computer to store said first image genetically.

95. The computer program product of claim 69 wherein said computer readable code configured to cause a computer to store said first image is further configured to cause a computer to store said first image chemically.

96. The computer program product of claim 69 further comprising:
computer readable code configured to cause a computer to encrypt a data item of said report.

97. A computer program product comprising:
a computer usable medium having computer readable program code embodied therein configured to authenticate a first gem item, said computer program product comprising:
computer readable code configured to cause a computer to retrieve a report for a second gem item wherein said report comprises:
a first image of said second gem item; and
a second image of said second gem item; and
computer readable code configured to cause a computer to compare a feature of said first gem item to a data item in said report.

98. A computer program product comprising:
a computer usable medium having computer readable program code embodied therein configured to authenticate a report, said computer program product comprising:
computer readable code configured to cause a computer to generate said report for a gem item wherein said report comprises:
a first image of said gem item; and
a second image of said gem item; and
computer readable code configured to cause a computer to encrypt a data item of said report;
computer readable code configured to cause a computer to attempt to decrypt said data item; and
computer readable code configured to cause a computer to authenticate said report if said data item is decrypted successfully.

99. The report authenticating system of claim 98 wherein said computer readable code configured to cause a computer to attempt to decrypt comprises:
computer readable code configured to cause a computer to operate a reading device.

100. A computer program product comprising:
a computer usable medium having computer readable program code embodied therein configured to inform, said computer program product comprising:
computer readable code configured to cause a computer to capture a first image of a gem item;
computer readable code configured to cause a computer to capture a second image of said gem item;
computer readable code configured to cause a computer to store said first image as part of a report for said gem item;
computer readable code configured to cause a computer to store said second image as part of said report for said gem item; and
computer readable code configured to cause a computer to display a data item of said report to a viewer.

101. The computer program product of claim 100 wherein said viewer is a student.

102. The computer program product of claim 100 wherein said viewer is a researcher.
